(19) United States
(12) Patent Application Publication
(10) Pub. No.: US 2007/0078949 A1
(43) Pub. Date: Apr. 5, 2007

(54) SYSTEM AND METHOD FOR MOBILE RETRIEVAL OF ELECTRONIC CONTENT FOR SEPARATE DELIVERY

(76) Inventors: Lawrence A. Washington, Ballwin, MO (US); Kevin B. Pfarr, Ballwin, MO (US)

Correspondence Address: CHARLES C. MCCLOSKEY, 763 S. NEW BALLAS ROAD STE. 170, ST. LOUIS, MO, 63141, US

(21) Appl. No.: 11/532,802

(22) Filed: Sep. 18, 2006

Related U.S. Application Data
(60) Provisional application No. 60/596,346, filed on Sep. 19, 2005.

(51) Int. Cl. G06F 15/16

(52) U.S. Cl. 709/217

(57) ABSTRACT

A system and method for remotely activating and remotely initiating retrieval of a content data file using a mobile communications device with public network access; a remote polling cycle and a playback device for retrieval of the content data file; and, a notification of file retrieval completion sent to the user of the system by the an electronic message to the device of the user's choice. The system and method remotely manage delivery of dynamic online content on various playback devices. The system and method perform remote activation, initialization, and notification, of content data file retrieval utilizing wireless communication devices having an application interface.

### CROSS REFERENCE TO RELATED APPLICATION

This non-provisional application claims priority to the provisional application for patent Ser. No. 60/596,346 which was filed on Sep. 19, 2005 which is incorporated by reference and the aforesaid application is commonly owned by the same inventors.

### BACKGROUND OF THE INVENTION

The present invention relates generally to the field of dynamic online content data file retrieval, and more specifically to a system and method for mobile retrieval of electronic content for separate delivery.

Mobile devices communicating through Wireless Application Protocols (WAP) and Internet Protocols (IP) have significantly improved remote transfer and reception of data from a multitude of sources. Devices, such as cell phones, personal computers, or PC, and personal digital assistants, or PDA, run a plurality of markup language applications from the touch of a button, communicate with various middleware programs that allow for a broad range of functionality. However the functionality to provide and to manage online based content download services for remotely located third party playback devices stills remains limited. For example, a playback device connected behind a personal firewall has its download capability restricted. This loss in functionality appears as inability to manage dynamically based online content download services and limits users of such services to remain in the same room as the playback device when connecting for a download.

Today's video on-demand content network architecture shows content owner established rules that allow for the constant changes in the amount of content available for download thereby causing the dynamics in the service. Typical video on-demand content based business rules are measured in the amount of time that a particular piece of content remains active on a system. This time is called content windowing and typically causes a particular piece of content to remain available from one to several weeks before removal. Rules that call for the expiration of content keep service providers actively changing menu structures, and adding and removing content through content windowing to follow licenses from content owners, and intermediate providers and distributors. These changes prevent a predetermination or choice by subscribers, or users, relating to selecting remotely a content data file, or CDF, through automated applications that process static, or non-dynamic, content data. More recent technology allows for a broad range of uses on today's communications networks using applications installed on mobile communications devices. An ability to manage such devices from a remote location has also expanded among the entertainment industry, such as gaming, music, and movie trailers. With the introduction of wireless technologies, mobile applications have been a primary source for data communications over cellular networks allowing for peer-to-peer connection via PDA, handheld gaming consoles and advanced mobile phones.

Such peer-to-peer communications allow these devices to share data, providing one user the ability to send another user content like a music file or movie file to view and to hear for a time period as licensed by the provider of the content. These networks also allow for the user to manage a mobile communications device from a PC sitting behind a personal firewall.

Due to the viruses, spyware, and Internet Worms, users needed to install a personal firewall to protect their data and identities. Most of today's firewalls, as delivered, allow user initiated connections through the device. Most homes today contain multiple PC connected to the Internet. Such devices as wireless routers also contain a personal firewall configuration that allows for minimum user intervention and for issuing of private Internet Protocol (IP) addresses to the additional PC on the network via a DHCP server integral, or installed, with the router. This type of configuration is known as a private network due to the inability to route such private addresses to the Internet. Configuring these devices to allow inbound connections from a mobile communications device to manage playback devices like DVD players, VCR's, set top boxes and media centers makes things more complex for users, often puzzled by VCR clocks.

Software modules have been developed for unattended mode fetching of content data information as in updates for publications or software subscriptions, commonly seen as automatic update features. These modules allow for little user intervention and solve the problem of remotely initiating transactions through a personal firewall. However these modules limit the user's ability to remotely choose content based on a dynamically changing library of content data thereby restricting user choice to the application installed on the local device. The patent to Nemirofsky et al. U.S. Pat. No. 5,880,769 shows a smart card system for transactions via a television. Like your invention, this smart card sends and receives information by a television signal to arrange for video and other services. Unlike your invention, this smart card receives information optically and communicates over the telephone lines using a modem to a central remote service. The television transmits the optical information, visible and non-visible to the smart card. This patent provides a television signal reading smart card and modem which is not your invention.

In the prior art, the publication to Barzebar et al., No. 02/0044199, shows a television remote control that serves as a telephone. As in the present invention, the patented control receives and transmits a telephone call. The control has a speaker that rings and receives the user's voice. The control provides the caller's voice signal to the television audio for broadcast into a room. In contrast to the present invention, this control works within infra red range of the television. This publication discloses a remote control used as a telephone for voice communication near a television, while the present invention uses a cell phone to order content for display onto a television.

The publication to Yuen, No. 02/0052197, describes another system that links a television to a central site by telephone. As in the present invention, this publication has a user purchase a television program through a remote control. The control sends a buy signal to the television circuitry which places a telephone call to a central site for ordering and delivery of a program. However, this publication again uses the remote control but not a cell phone, and the telephone system to transmit order information then it mentions a confirmation message.

The publication to Rakib, No. 02/0059637, has a gateway in a residential entertainment setting that communicates with a headend that has content. This publication describes a satellite receiver and a CPU coupled with a hard drive. The hard drive records video downloaded by the CPU similar to present day TiVO. This publication describes an infrared remote control, likely meaning under 20 foot range or a residential setting. The CPU does communicate by conventional modem and cable modem. The publication makes little mention of remote access by cell phone.

Then the publication to Mizutani et al., No. 02/0138846, has a two part communication system that measures media quality and prices the media by it. The system has an authentication means as in the present invention and it delivers media digitally using an IP protocol. The publication does not claim remote accessibility to operate the system and does not indicate scheduling or delivery of the media as in the present invention.

The publication to Lupulescu et al., No. 03/0030751, shows a cell phone used to order a pay per view movie from a satellite television provider. Similar to the present invention, this publication has a cell phone with software that allows a user to remotely select, order, and pay for video content. The software also has an email delivery feature to remind a user about the start of a movie. The cell phone is described as WAP enabled. In contrast to the present invention, this publication does not describe any features on a set top box. However, this publication approaches the cell phone features of the present invention.

The publication to Weber et al., No. 03/0236843, has an assembled radio broadcast for a user. As in the present invention, the publication provides content selected by the user through a group of smart receivers. The receivers each follow a feed (music, video, or ad) and the smart part of the publication combines selections from each feed to match a user's playlist. However, the publication does not describe remote ordering of playlist content by a cell phone. The multiple feeds and receivers of this publication separate it from the present invention.

Urakoshi has a publication No. 02/0117841 describing a digital receiver that does not charge users for non delivery of programs. The receiver has software that monitors the preview of a program and then charges the user if the program has sufficient quality. The publication mentions a remote transmitter 10 that is likely an infra red controller. This publication does not describe remote access and payment by cell phone beyond infra red range in the present invention.

And similar to the Lupulescu publication, Benco et al. shows a wireless content ordering system in publication No. 05/0278766. This system uses a cell phone, or Bluetooth device, to communicate with a set top box for ordering video content. This system can detect if a user is using the cell phone and switch to another channel to place a content order. This system displays the content available on a television but not the cell phone.

### SUMMARY OF THE INVENTION

The system and method of the present invention are devices and software that allow users to download electronic content to one player device from another device located remote from the player.

The present invention remotely manages dynamic online content delivery generally related to content data file playback devices, or playback devices. It broadly relates to a system and method for remote activation, initialization, notification, of content data file retrieval utilizing wireless communication channels over public networks accessed from a mobile communication device having a mobile application interface.

In the preferred embodiment of the present invention, a system remotely activates content data file retrieval. A mobile communications device, having public network access, allows users, located outside of the range of the remote content data file playback device to select the content data file. The mobile application interface of the present invention remotely displays a personal electronic document over the wireless communication channels, simulating the remote content data file playback device via an Interactive Program Guide. The personal electronic document has a structure for the users to navigate through content data file categories that follow a readable clear text naming convention. As the mobile communications device and the remote content data file playback device do not share the same address conventions, selection information passes over a remote WEB application server across the public network to synchronize the information with a relational database. The relational database is remotely queried by the remote content data file playback device's polling cycle application.

Also in the preferred embodiment of the invention, a method remotely activates content data file retrieval. The method comprises generating a request for a personal electronic document when the user initiates a session using the mobile application interface. The mobile application interface displays the personal electronic document in a high-level markup language format transmitted from a WEB application server with a list of content data file categories and navigational buttons to select the content data file. The submission of the content data file travels with a user session ID to a personal electronic document profile relational database where the submitted information is then transmitted to a second relational database that updates the personal electronic document profile information with the address of the content data file and queues the file for retrieval.

In an alternate embodiment of the invention, a method retrieves remotely a content data file and notifies a user thereof. The method has the steps:

1 a remote content data file playback device initiating a prescheduled polling cycle application that has the network layer address information of the personal electronic document profile information relational database,

2 a secure connection to authenticate the remote content data file playback device,

3 the polling cycle application locating the content data file computer hashed address storage location within the personal electronic document profile information content address data field,

4 initiating a second session on the remote content data file playback device in which resides the network layer address of the content storage node array resulting from a query of the content data file,

5 issuing file retrieval commands in a second session over the secure connection for retrieving the content data file,

6 sending transport layer acknowledgements from the remote content data file playback device to acknowledgement data fields within the personal electronic document profile information relational database upon completion of file retrieval thereby transmitting session information and notification messages to the network layer address of the electronic messaging server, and

7 processing session information on the electronic messaging server and transmitting electronically formatted messages to the user's preferred method of notification within his personal electronic document profile information.

The primary object of the invention is remote content data file retrieval, using the mobile communications device on a public network access to wireless communication channels.

Another object of the invention is using a mobile application interface to browse through personal electronic documents to select a content data file for retrieval by the remote playback device.

Another object of the invention is notification through communication of file retrieval completion by an electronic message sent to the user's device of choice.

These and other objects may become more apparent to those skilled in the art upon review of the summary of the invention as provided herein. In addition, the invention will be better understood upon undertaking a study of the description of its preferred embodiment, in view of the drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown enlarged to ease understanding of the invention.

In referring to the drawings,

FIG. 1 shows an example of an overall system diagram of the preferred embodiment of the present invention;

FIG. 2 shows a diagram illustrating the information path from the mobile communications device and the synchronization of information from the personal electronic document through the WEB application server to the personal electronic profile information relational database;

FIG. 3 shows a diagram illustrating the information update paths through the WEB Application Engine and the functions of the notification element; and,

FIG. 4 shows a flow chart of the initiated polling cycle application of the remote content data file playback device.

The same reference numerals refer to the same parts throughout the various figures.

### DESCRIPTION OF THE PREFERRED EMBODIMENT

The present invention may be embodied in various forms. Therefore, specific details disclosed herein are not limiting, but rather form a basis for the claims. Further, in the detailed description to follow, the acronyms:

CDF, MAI, PED, PEDP, PEDPI will be used to describe the following:

Content Data File, Mobile Application Interface, Personal Electronic Document, Personal Electronic Document Profile, Personal Electronic Document Profile Information, respectively.

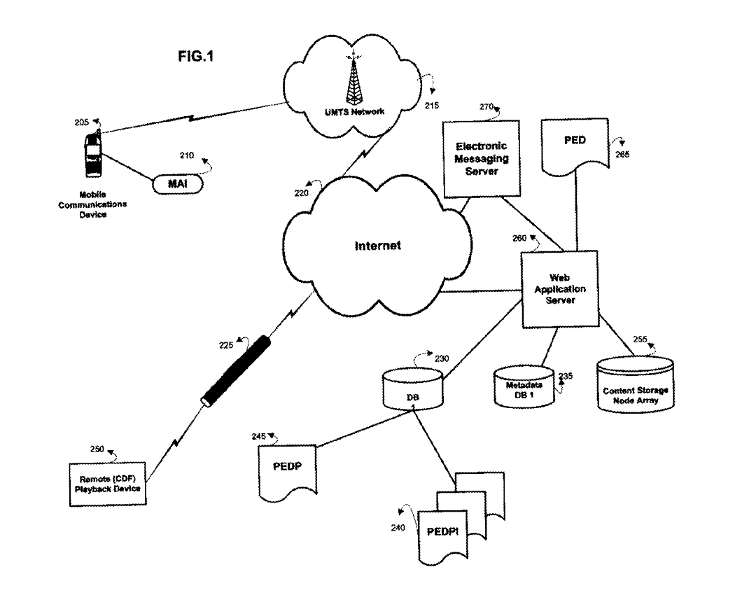

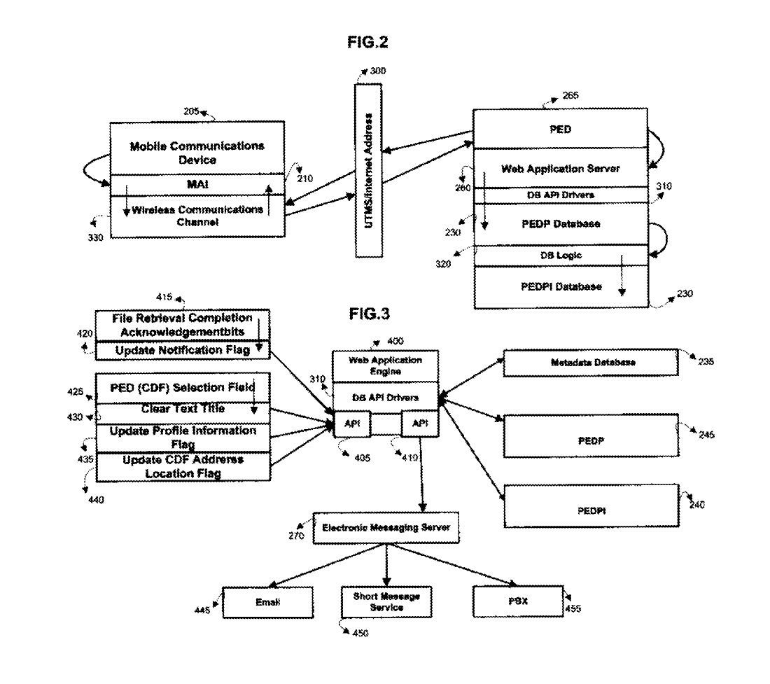

FIG. 1 illustrates an overall system diagram of an embodiment of the present invention. In this example a mobile communications device 205 serves as a gateway device to connect through the Universal Mobile Telecommunication System (UMTS) network 215 to access the Internet 220. The MAI 210 initiates, upon request of the user for seeking a PED 265 hosted by the WEB application server 260 where the user may browse and select content advertised by the provider. The mobile communications device 205 may be a cellular telephone, PDA, or a handheld gaming unit and may have the capability to display HTML, XML, XHTML, or WAP formatted documents, and capability to process wireless RF signals. Once the user submits his selection, the WEB application server 260 communicates with the relational database 230 to synchronize information to the PEDP 245 through configured DB API Drivers 310, later described in FIG. 2. Before data synchronizes to the PEDPI 240, the selected content address is checked against the Metadata database 235.

At scheduled intervals, the playback device 250 initiates a secure communications channel, or VPN 225 through the Internet 220 to check the PEDPI 240 for updated information using the Update Profile Information Flag 435, later described in FIG. 3.

Upon finding the Update Profile Information Flag 435 set within the PEDPI 240, the playback device 250 then checks the Update Content Address Location data field 560 for the storage address of the CDF. After successful location and retrieval of the CDF from the Content Storage Node Array 255, the playback device 250 sends acknowledgements to the WEB Application server 260 activating the Update Notification Flag 420. The WEB application server 260 receives retrieval acknowledgement from the playback device 250. The information then passes to both the PEDPI 240 and the Electronic Messaging server 270 through the use of the respectable API's and thereby notifies the user that the CDF is stored on the playback device 250, ready for viewing or listening. The playback device 250 may be a DVD player, VCR, Media Center, Digital Set Top, PVR, DVR or any device capable of displaying audio/video CDF, having VCR like functions and the ability to store CDF within directories, and a means for processing network communication protocols.

Yet, mobile devices 205 continue to advance and support greater volumes of XHTML and standard HTML code as processing power in handsets increases. It is likely WML will be phased out in the future. The present invention utilizes mobile devices 205 that can retrieve applications which run locally on the device. These local applications display advanced web driven menu's that use the HTTP protocol to communicate to a web application server. In one embodiment of the locally application, the user simply dials into a soft switch, such as an Astricks Server from the mobile communications device 205. The user and any CDF can be determined using a combination of Automatic Number Identification (ANI) information and user answered prompts. This information then authenticates the user and matches the user to an account, including a preselected cellular email address that the application communicates upon. Next, following the email delivery of an application to a mobile device 205, the user follows the link to initiate the installation of the application. This application displays the necessary pages hosted by the web application server. The navigation through the content menu emulates existing program guides, presently shown on cable or CATV systems. The navigation also authenticates the user upon its launch. The present invention embodies two ways to communicate to the web applications server without using an application gateway device that will translate one protocol to the other as in WML or WAP capable devices.

FIG. 2 is illustrates the information path from the mobile communications device 205 and the synchronization of information from the PED 265 through the WEB application server 260 to the PEDPI database 230 in the present invention. The user of the mobile communications device 205 initiates a session to the PED 265 on a wireless communications channel 330 over the Universal Telecommunications Mobile System (UTMS) network 300 for routing through the network gateway devices to the Internet address 300 of the WEB application server 260.

The PED 265 is created using such markup languages as HTML, XML, XHTML, WAP based pages and XSLT that are viewable on a browser client that the MAI 210 uses to display the PED 265. At the far end of the communications path, the WEB application server 260 communicates to the PEDP database 230 and updates content selection through the use of the DB API Drivers 310. The DB API Drivers 310 interfaces the communications from the WEB Application Engine 400 to the database language structure to pass commands and Flags to be processed by the database. As information passes from the PED 265 through the WEB Application Server 260 to the PEDP database 230, a second transaction is initiated by the DB Logic 320 to pass the information updates to the PEDPI database 230.

FIG. 3 describes the information update paths through the Applications Engine 400 and the functions of the notification element in the preferred embodiment. As the user of the PED 265 selects a CDF for retrieval two events occur:

1) the PED CDF Selection Field 425 is populated with the Clear Text Title 430 of the selected CDF and two, the Update Notification Flag 435; and,

2) the Update CDF Address Location Flag 440 are queued for submission to the WEB Application Engine 400.

The WEB Application Engine 400 processes the flags to the appropriate WEB client API 405 which then passes the flags to the DB API Drivers 310 where the flags are processed using DB Logic 320. In particular, the Update CDF Address Location Flag 440 is processed by the DB API Drivers 310 for locating the Clear Text Title 430 mapping to the computer hashed CDF address stored on the Metadata Database 235. The mapped address of the CDF address is then sent back to the DB API Drivers 310 to be processed to the PEDP 245 and then synchronized with the PEDPI 240 along with the Update Profile Information Flag 435 using DB Logic 320 where the CDF address location will be stored in the Content Data File location field 560.

Upon file retrieval completion 415 of the CDF, the playback device 250 will send acknowledgement in the form of an Update Notification Flag 420 to the appropriate WEB client API 405 within the Web application Engine 400 to initiate the notification process. This process includes the Update Notification Flag 420 being sent to the DB API Drivers 310 where it is then be processed by DB Logic 320 to the PEDPI 240. DB Logic 320 determines the user's preferred method of notification and returns to the WEB application Engine 400 with the appropriate information to communicate the preferred method of notification to the notification client API 410. The user has previously configured an account, accessed by the notification client API 410, for delivery of the notification to the user. The notification client API 410 communicates directly with the Electronic Messaging Server 270 to process the preferred method of delivery using either Email 445, short message service 450, PBX 455 protocols, and the like.

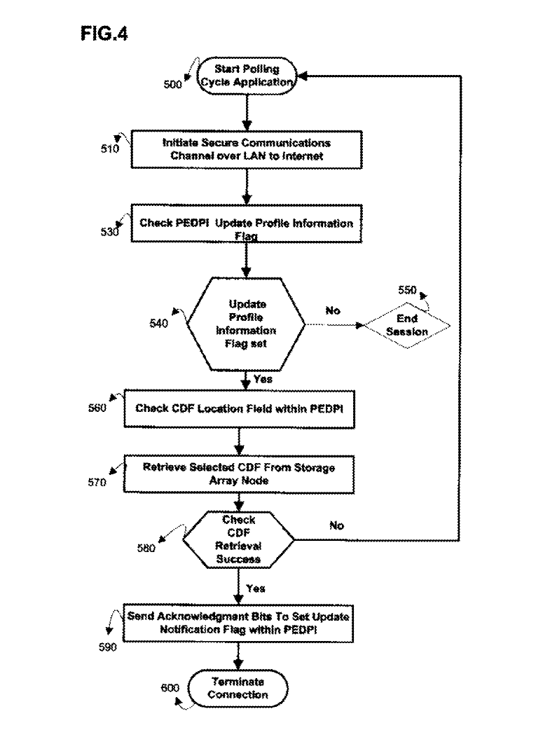

And, FIG. 4 is a flow chart of the initiated polling cycle application of the playback device 250 used by an alternate embodiment of the present invention. As the playback device 250 is remote, or separated, from the user at the time of CDF selection, a process retrieves the selected CDF for playback. Prescheduled by the user, this process starts by execution of application 500 and terminates in application 600 in this figures. Upon the activation of the polling cycle application 500 the playback device 250 immediately proceeds to operation 510. In operation 510 the playback device 250 initiates a VPN connection across the Internet 220 and authenticates itself using the appropriate software as configured under the VPN client installed on the playback device 250.

Thereafter in operation 530, the polling cycle application initiates a communication session with the PEDPI database 230 and verifies the PEDPI 240 for the activation of the Update Profile Information Flag 435 and proceeds to operation 540. Upon finding that the Update profile information flag 435 has not been activated, the polling cycle application proceeds to operation 550 and ends the session by terminating the connection; however if in operation 540 the Update Profile Information Flag 435 has been set, the polling cycle application proceeds to operation 560. Thereafter, checking the PEDPI 240 for the CDF Location Field to determine the storage location of the CDF, the polling cycle application begins transferring a file with the Content storage node array 255 in operation 570 using such appropriate file transfer protocols as FTP GET commands and alternatively HTTP GET, SFTP GET and TFTP GET and the like commands. The polling cycle application then proceeds to verify the integrity of the file transfer by comparing the checksums in operation 580. Upon failure of file transfer, operation 580 restarts the polling cycle application in application 500. Following a successful file transfer in operation 580, the polling cycle application proceeds to operation 590 by sending acknowledgement upstream to the PEDPI 240 setting the Update Notification Flag 420, and signifies the notification of file retrieval completion to the user thereby ending the session in operation 600.

Variations or modifications of the subject matter of this invention may occur to those skilled in the art upon reviewing the disclosure provided herein. Such variations or modifications are intended to be encompassed within the scope of the invention as described herein. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. The description of the preferred embodiment and of the drawings showing the same are provided herein for illustrative purposes only.

From the aforementioned description, a system and method for the mobile retrieval of electronic content for separate delivery. The system and method are uniquely capable of managing electronic content download separately and remotely from a playback device. The system and its various components may be manufactured from many materials including but not limited to polymers, silicone, high density polyethylene HDPE, polypropylene PP, polyethylene terephalate ethylene PETE, polyvinyl chloride PVC, nylon, ferrous and non-ferrous metals, their alloys and composites.

The phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A system for remotely activating content data file retrieval, the system comprising:
a mobile communications device having public network access over a wireless data communications channel;
a mobile application interface to browse personal electronic documents to select the content data file for retrieval; and,
a remote playback device, separately located from said mobile communications device, and playing said content data file upon request of said mobile communications device.

2. The system of claim 1 wherein the mobile communications device is a device competent of processing wireless communications signals utilizing a mobile application interface capable of displaying a plurality of markup language types.

3. The system of claim 1 wherein the mobile application interface resides in a physical memory address location of the mobile communications device and is configured to request the personal electronic document information.

4. The system of claim 1 wherein said personal electronic document is hosted from a remote web application server having configurable synchronization to a second file located on a centralized cluster of relational databases.

5. The system of claim 1 further comprising:
said playback device decoding a content data file and performing recordation and playback of said content data file therein.

6. The system of claim 5 further comprising:
a communications device for accessing remote networks and storage devices of content data files for playback.

7. A method for remotely activating content data file retrieval, the method comprising:
generating a request for a personal electronic document;
selecting the content data file for retrieval;
updating a first information set from the personal electronic document to a personal electronic document profile; and,
synchronizing a second information set from the personal electronic document profile to the personal electronic document profile information.

8. The method of claim 7 wherein the personal electronic document profile is remotely stored on a mass storage node.

9. The method of claim 7 wherein the personal electronic document profile information is remotely stored on a mass storage node.

10. The method of claim 8 wherein the mass storage node hosts central database for the personal electronic document profile.

11. The method of claim 9 wherein the mass storage node hosts central database for the personal electronic document profile information.

12. The method of claim 7 wherein the personal electronic document profile information contains at least one device hardware address and at least one piece of user identification information.

13. The method of claim 7 wherein the personal electronic document content selection data fields dynamically map the content data file to the content data file storage location.

14. The method of claim 7 wherein the content selection data population sets an update profile information data flag within the personal electronic document profile.

15. A method for remotely initiated content data file retrieval to a playback device and notification thereof to a communication device, the method comprising the steps of:
initiating a polling cycle on a playback device to a separately located communication device at predetermined intervals;
retrieving a file by said playback device from a content storage node array over a public network using secure communication channels; and,
updating said storage node array, said communication device, and said playback device upon completion of file retrieval.

16. The method of claim 15 further comprising:
said polling cycle opening a secure communications channel to encrypt data and to verify content directory information upon said storage node array.

17. The method of claim 15 further comprising:
said polling cycle verifying content directory information for the location of a content data file and using remote GET commands for retrieving a content data file.

18. The method of claim 15 further comprising:
sending acknowledgement bits upstream by said playback device to said storage node array and activating an update notification data flag.

19. The method of claim 18 further comprising:
said update notification data flag triggers a notification message to an electronic messaging server to notify a user of said method.

20. The method of claim 19 further comprising:
said electronic messaging server linking an update notification message to a user of said message; and,
said electronic messaging server using a plurality of messaging protocols to notify the user.
